(19) United States
(12) Patent Application Publication
(10) Pub. No.: US 2011/0100928 A1
(43) Pub. Date: May 5, 2011

(54) PREPARATION AND USE OF NANO SIZE PEROXIDE PARTICLES

(75) Inventor: Wei-xian Zhang, Bethlehem, PA (US)

(73) Assignee: LEHIGH UNIVERSITY, Bethlehem, PA (US)

(21) Appl. No.: 12/610,806

(22) Filed: Nov. 2, 2009

(51) Int. Cl. A62D 3/38; C09K 3/00; C02F 1/72

(52) U.S. Cl. 210/759; 252/186.43; 588/320

(57) ABSTRACT

Nano-size particles of calcium dioxide and magnesium dioxide for remediation of contaminated water or soil and processes for preparing and using nano-size particles of calcium dioxide and magnesium dioxide.

### BACKGROUND

Environmental pollution caused by hydrocarbon chemicals is a serious and very widespread environmental problem. Each year, over 1,300 billion gallons of petroleum is consumed. The inevitable result of handling such a huge volume of petroleum and its products is the frequent and widespread contamination of the environment. For example, transporting petroleum products in ships, trucks, and pipelines regularly leads to accidents and spills. Fuel tanks are prone to corrosion, which often causes leaks. According to the United States Environmental Protection Agency (US EPA), there are over 500,000 Leaking Underground Storage Tanks (LUSTs) in the U.S. Complete remediation of those sites would cost billions of dollars.

Current practices of hydrocarbon remediation include pump-and-treat, soil vapor extraction (SVE), bioremediation, and chemical oxidation. Those methods have proved to be time consuming, ineffective and consequently expensive. For example, in situ bioremediation uses microorganisms to degrade contaminants in place with the goal of obtaining harmless hydrocarbons and carbon dioxide as the end products. Often it takes many years to meet the objectives of site cleanup and remediation. Repeated injections of oxygen and nutrients are typically needed. Chemical oxidation using hydrogen peroxide has also been used frequently. However hydrogen peroxide is fully miscible with water and highly mobile in groundwater. It's effectiveness is limited as the dissolved hydrogen peroxide is rapidly dissipated and reacted.

### SUMMARY

This invention pertains to production and use of solid or porous peroxide nanoparticles for hydrocarbon remediation. Peroxide nanoparticles refer to solid or porous particles of calcium dioxide or magnesium dioxide with average size in the range of 1 to 1,000 nm. They are formulated and synthesized for fast subsurface injection, dispersion and for enhanced reactions to achieve accelerated oxidation of hydrocarbon compounds. The particles are effectively used in processes to treat and remediate soil and groundwater, and sites contaminated with petroleum hydrocarbons such as gasoline, diesel, jet fuel, heating oil and other fuel oils.

The materials of the invention provide controlled release of hydrogen peroxide that can remain reactive for days and weeks.

### BRIEF DESCRIPTION OF THE DRAWINGS

FIG. 1a is a photograph (1×) of an underground fuel tank.

FIG. 1b is a schematic reproduction of dispersion of contaminant leaking from a storage tank.

FIG. 2 is a schematic diagram of a milling process for preparing nano-size peroxide particles.

FIG. 3a and FIG. 3b are images by electron microscopy of calcium dioxide particles before milling.

FIG. 3c and FIG. 3d are images by electron microscopy of calcium dioxide particles after milling.

FIG. 4a is a plot of x-ray diffraction particles for freshly milled calcium dioxide particles.

FIG. 4b is a plot of x-ray diffraction particles for nano-size calcium dioxide aged in deionized water for eleven days.

FIG. 5a is a plot of gas chromatograms of gasoline in water before treatment.

FIG. 5b is a plot of gas chromatograms of gasoline in water after exposure to calcium peroxide nano-size particles.

FIG. 6a is a photograph of a water and gasoline mixture after separation of the gasoline from the water.

FIG. 6b is a photograph of the mixture of FIG. 6a after introducing nano scale particles of calcium peroxide.

### DETAILED DESCRIPTION OF THE INVENTION

Remediation of the soil and water that has been contaminated by leaking fuel tanks is a significant problem.

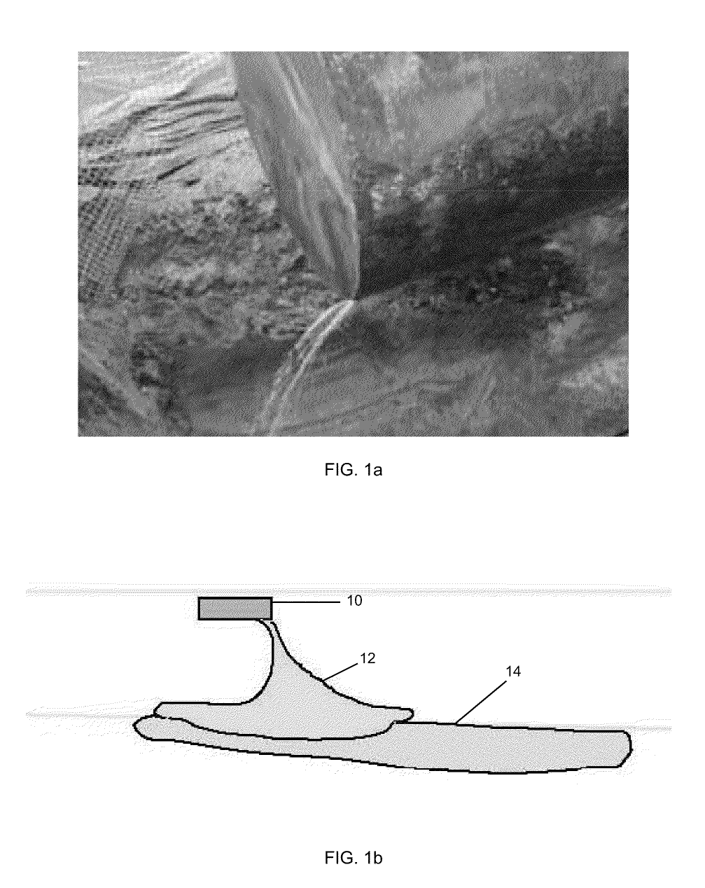

As shown in FIG. 1a, many buried fuel tanks are susceptible to developing leaks over time. FIG. 1a shows significant leakage as the tank is being extracted from the ground for replacement.

As shown in FIG. 1b, the tank 10 can cause stored fuel, be it gasoline, gasoline derivatives, oil products and the like, as a discharge 12 into the soil and the underlying ground water 14.

It has been suggested that solid peroxide can be used to remediate the situation by reacting with the leaking material to render it non-toxic with the reactive products being removed from the soil or water. However, it has been found that conventional calcium dioxide particles are too large and will not disperse and especially will not move with the ground water flow to effect the remediation.

It has been discovered that producing nano-size particles of calcium dioxide or magnesium dioxide and introducing the particles into the ground water or the surrounding soil in the form of an aqueous slurry will magnify the reaction between the peroxide particles and the contaminants and reduce the reaction time of months to years with large particles to less than ten weeks with the nano-size particles of the peroxide.

The nanoparticles according to the invention rely on chemical and biological oxidation of the hydrocarbons. Chemical oxidation is achieved by the release of hydrogen peroxide from the solid peroxide and formation of hydroxyl radicals. The formation of dissolved oxygen stimulates the growth of micro organisms, which metabolize the hydrocarbons to cause biological oxidation of the hydrocarbon compounds, which then are converted to alcohol and fatty acid compounds—, which are more water-soluble compounds and can be readily removed from the water as it is brought out of the ground.

It has been discovered that producing solid or porous peroxide particles having a particle size from 1 to about 1000 nanometers results in a material that is effective for use in soil and ground water remediation.

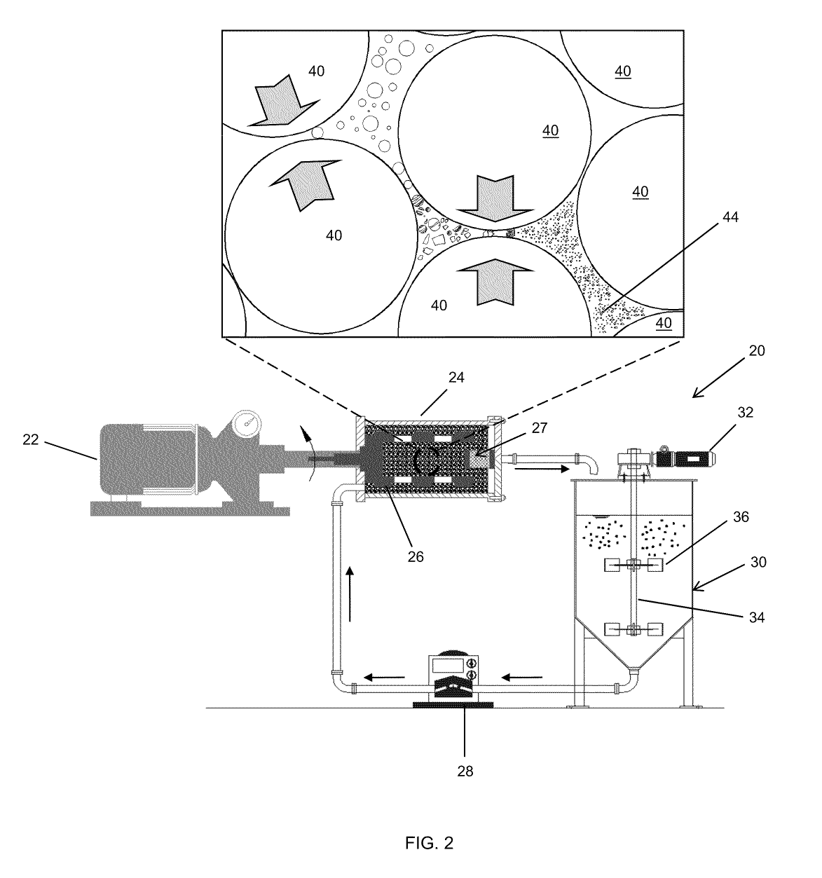

The nano-size peroxide particles are produced according to a process described in conjunction with the schematic diagram in FIG. 2.

As shown in FIG. 2, the process for producing nano-size peroxide particles is carried out in an apparatus 20 which includes 2 sub-units: 1) the milling unit consisting of a motor 22 capable of rotational speeds of 2000 to 2500 rpm, a grinding chamber 24, an agitator 26 and medium beads 40 inside of the grinding chamber 24, and 2) a particle circulation and cooling unit containing a pump 28 and a holding tank 30 to control the temperature of the peroxide suspension in the tank and inside the mill. The holding tank 30 includes a mixer motor 32 adapted to rotate a shaft 34 containing mixing paddles 36. The mixing apparatus 32, 34, 36 keeps the peroxide particles in suspension. In a typical milling cycle, 1-2 kg of solid peroxide (e.g., CaO₂ or MgO₂) can be processed each time. The settings used and the results achieved (e.g., power input, milling time, and product yield) on the milling system for this invention are linearly scalable for large-scale production-sized mills, which can process over 1,000 kg each time.

A laboratory-use ball mill sold under the trade name Labstar used in proving this invention was obtained from Netzsch of Exton, Pa. As shown in FIG. 2, the motor 22, through a shaft connected to the agitator 26, provides the milling power (Pₘₐₓ=2.6 kW). The agitator 26 is a hollow cylinder with arms and open slots which fits concentrically in the stationary grinding chamber 24 that has a capacity of approximately 700 ml. 450 ml (apparent volume) of steel beads (dia. 250 μm) is loaded into the chamber as the milling medium. During milling, the motor drives the agitator at a designated rotating speed (˜2000 rpm) to stir up the milling medium (beads). The solid peroxide particles are impacted by the moving beads, and the impact energy fractures the material into smaller pieces. A stainless steel cylinder screen 27 with laser-cut 100 μm slots is fitted into the open end of the agitator 26 and functions as a filter to retain the milling beads but allows the processed peroxide material to pass through screen 27 into the holding tank 30. From the holding tank 30, the peroxide particles are recycled back to the milling system by the circulation pump. Energy input to the system can be adjusted by the pump speed and the rotating speed of the agitator.

Total milling time is about one hour. The nanoparticles can also be processed in a continuous mode without the recirculation.

Superimposed on top of FIG. 2 is a schematic representation of the process within the grinding chamber 24. As shown in that portion of FIG. 2 the media beads 40 impact the large peroxide particles 42 until smaller nano-sized particles 44 are produced which will pass through screen 27.

SEM imaging was performed using a field-emission SEM (Hitachi S-4300) operating at 5.0 kV. Specific surface area of the peroxide particles was measured using a Micrometrics Flowsorb 2305 following the classic Brunauer-Emmett-Teller (BET) method. Dried samples were first degassed at 170° C. for 40 minutes. Adsorption of pure nitrogen by the peroxide sample was done in a sample tube at prescribed conditions followed by desorption of nitrogen as temperature ramps up to room conditions. The amounts of nitrogen adsorbed and desorbed by the peroxide particles were measured and were used to calculate the total surface area and the mass-normalized specific surface area. Original (before milling)

calcium peroxide particles have BET surface area nearly 1 square meter/gram while the milled materials have BET surface area over 30-50 square meters/gram.

The as-prepared samples were analyzed with high-resolution X-ray photoelectron spectroscopy (HR-XPS) and X-ray diffraction (XRD) to determine their surface chemistry and crystal phase compositions. HR-XPS was carried out with a Scienta ESCA-300 instrument equipped with an Al rotating anode operated at 3.8 kW to produce 1486.6 eV Kα X-rays, seven crystals for X-ray monochromatization and a 300 mm mean radius hemispherical electron energy analyzer. A Rigaku diffractometer (Rigaku, Japan) with Cu Kα radiation generated at 40 kV and 30 mA was used to perform XRD analysis.

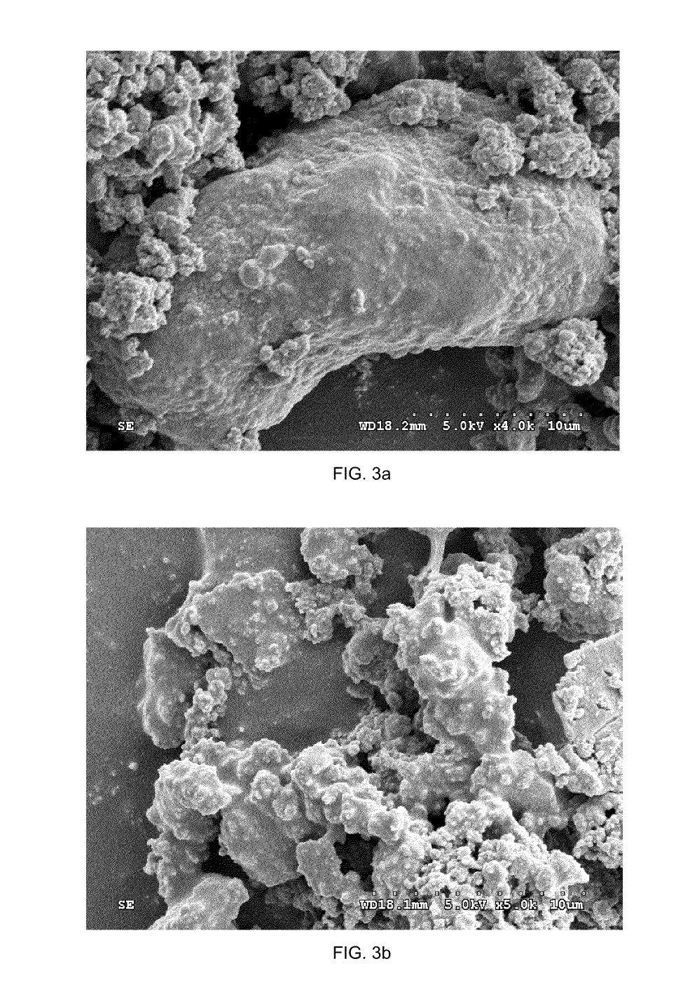

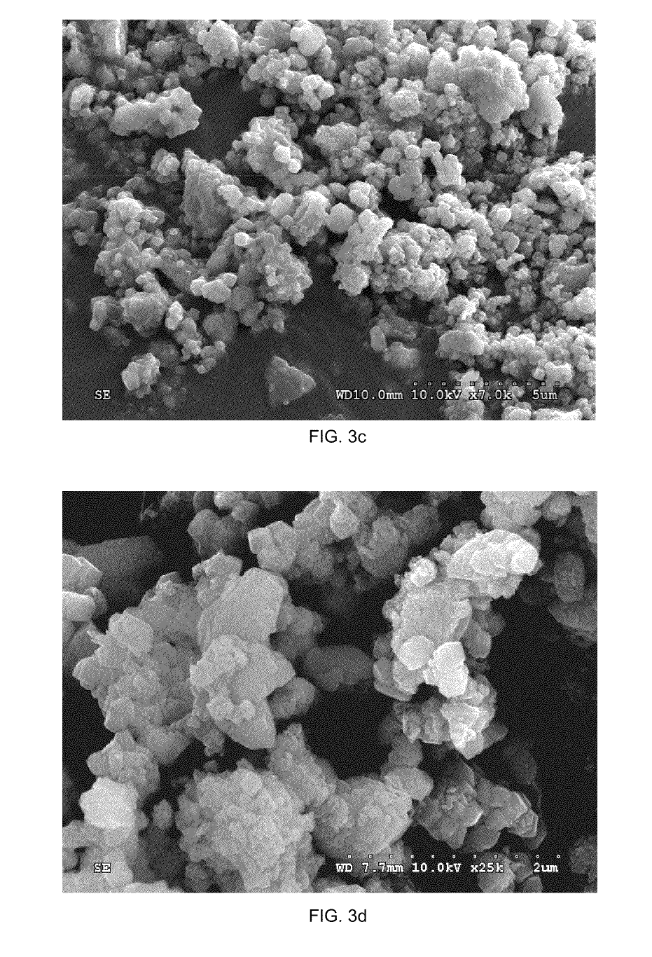

FIGS. 3a and 3b show SEM images of the calcium peroxide particles before milling according to the invention. FIGS. 3c and 3d show nano-size particles produced according to the invention. The original calcium peroxide sample had a highly non-uniform size distribution. Majority of the particles were greater than 1 μm in scale and occasionally chunky macro-particles as large as 20 μm were spotted as shown in FIGS. 3a and 3b. The particles exhibit irregular shapes and a clumpy texture, which appears like being formed by many smaller particles fused together.

The SEM images of the milled sample (FIG. 3c) shows the particles largely in the size range of 200-400 nm. Individual particles remain scattered or form loosely attached aggregates. A close up view shown in FIG. 3d reveals a significant amount of small cubic and rhombohedral structures exist in the sample. XRD was employed to determine these crystalline phases.

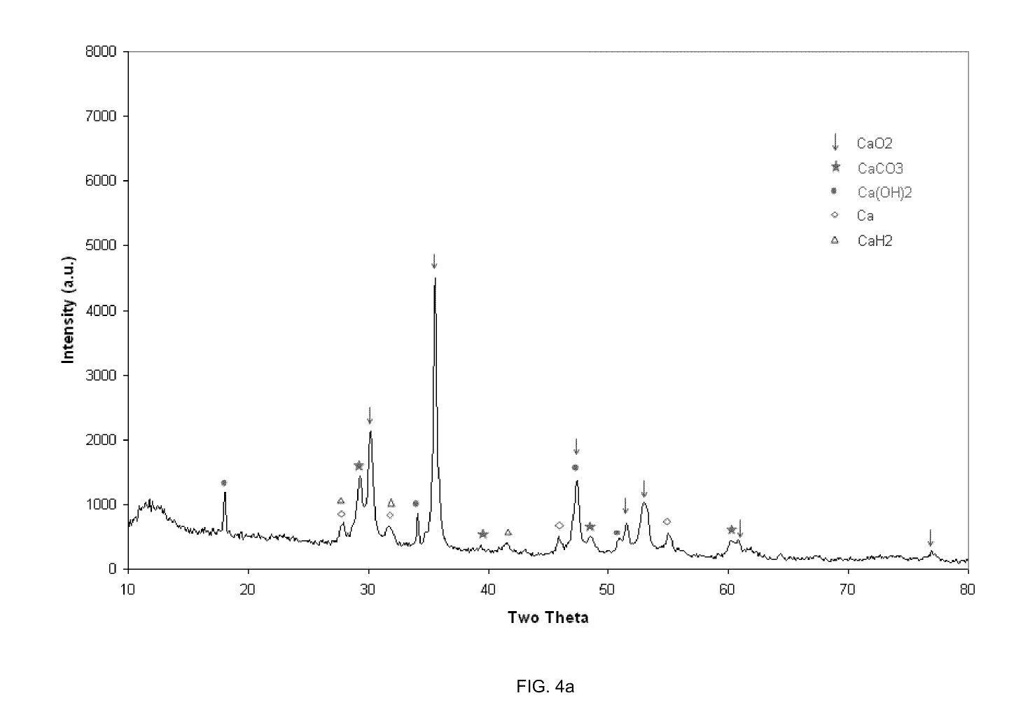

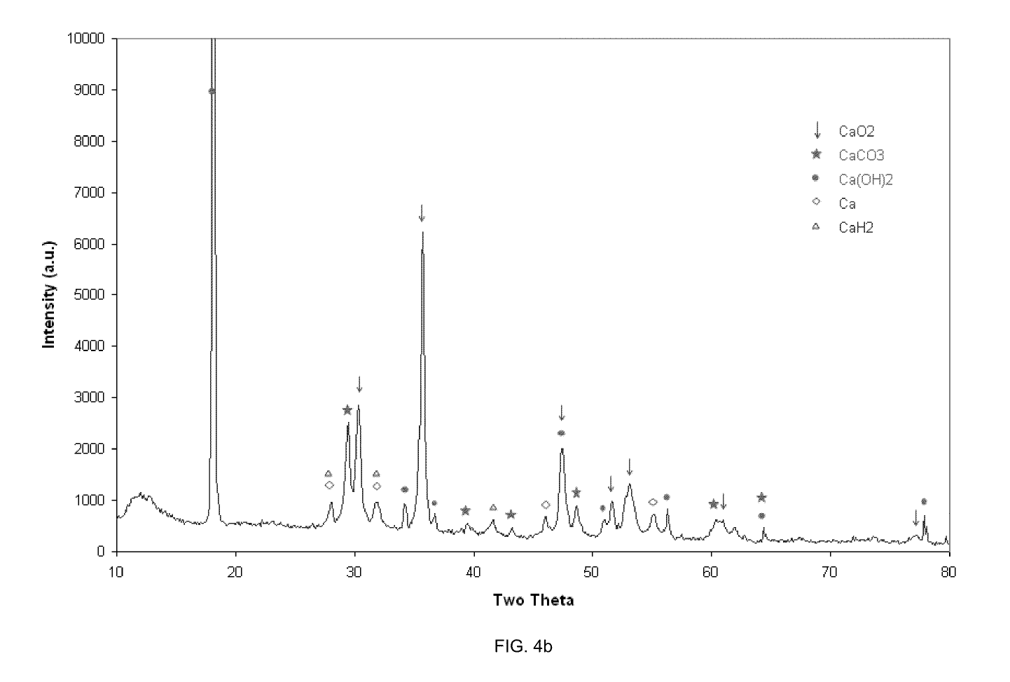

The resultant XRD pattern of the freshly-milled CaO₂, shown in FIG. 4a, indicates CaO₂ as the predominant mineral product, accompanied by Ca(OH)₂ and CaCO₃ in a lesser amount. The remaining minor peaks were assigned to Ca and CaH₂, which might be present in the sample as impurities. The fresh milled CaO₂ were dispersed in deionized (DI) water for 11 days and the products analyzed again by XRD. Compared to the fresh CaO₂, the diffraction pattern as shown in FIG. 4b of the aged CaO₂ sample exhibited a significant increase in a Ca(OH)₂ phase along (00n) planes (at 2q 18.2°, 36.7°, 56.3°, 77.9°), suggesting a substantial growth of Ca(OH)₂ in these directions during the aging process. In addition to Ca(OH)₂, the increased presence of CaCO3 is also observed, which reveals a fraction of CaO₂ was transformed to Ca(OH)₂ and CaCO₃ in water over the 11 day interval.

TABLE 1

| ID # | Name | Conc | Area | Ret. Time | Type | m/z | Height |
|---|---|---|---|---|---|---|---|
| 1 | benzene | 12.130492 | 26226 | 5.510 | Target | 78.00 | 9571 |
| 2 | Fluorobenzen | 1.000000 | 304058 | 5.701 | ISTD | 70.00 | 112502 |
| 3 | Toluene | 17.566283 | 117018 | 6.893 | Target | 91.00 | 48379 |
| 4 | Ethylbenzene | 13.698874 | 10216 | 7.998 | Target | 91.00 | 4544 |
| 5 | xylene-1 | 12.873778 | 29285 | 8.079 | Target | 91.00 | 12832 |
| 6 | xylene-2 | 13.102511 | 14634 | 8.391 | Target | 91.00 | 6431 |
| 7 | propylbenzen | 9.430242 | 1096 | 8.969 | Target | 91.00 | 475 |
| 8 | 3-1 | 10.584393 | 5957 | 9.031 | Target | 105.00 | 1633 |
| 9 | 3-2 | 38.655900 | 5957 | 9.031 | Target | 105.00 | 1633 |
| 10 | 3-3 | 9.065467 | 1536 | 9.265 | Target | 105.00 | 633 |
| 11 | 3-4 | 6.326833 | 3146 | 9.393 | Target | 105.00 | 1357 |
| 12 | 3-5 | 6.350706 | 691 | 9.733 | Target | 105.00 | 297 |

Table 1 sets forth data showing the degradation of gasoline with calcium peroxide nanoparticles. Table 1 identifies the chemical present in the sample. Compounds 8-12 in Table 1 are isomers trimethylbenzene.

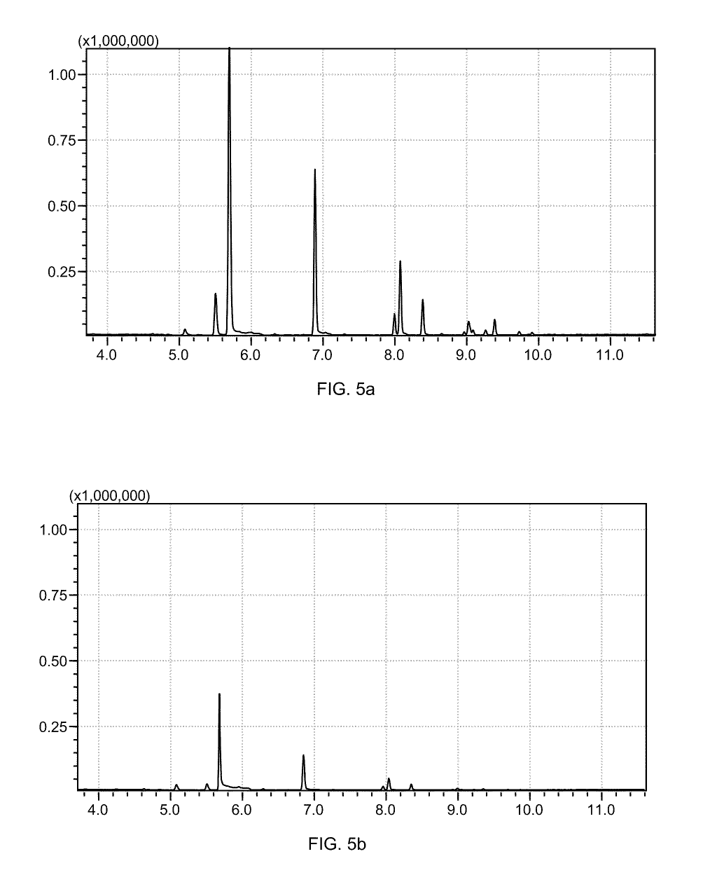

FIG. 5a presents gas chromatograms (GC) spectra of the gasoline in water (10% gasoline, 90% water) sample before treatment with calcium peroxide nanoparticles.

FIG. 5b is the spectrum after treatment with calcium peroxide nanoparticles. FIG. 5b shows gas chromatograms after 24 hours of reactions with calcium peroxide nanoparticles (5 g/L). Results show near complete degradation of hydrocarbons including benzene, toluene, ethylbenzene, xylenes and propylbenzene.

The largest (highest with a retention time of 5.7 minutes) peak is fluorobenzene which as added to the water sample at the time of analysis and is used as an internal standard for the purpose of quantification as the amount of fluorobenzene was known. Concentrations of other compounds were then calculated based on the relative ratios of their peak areas to that of fluorobenzene. Fluorobenzene was not present in the contaminated water or gasoline

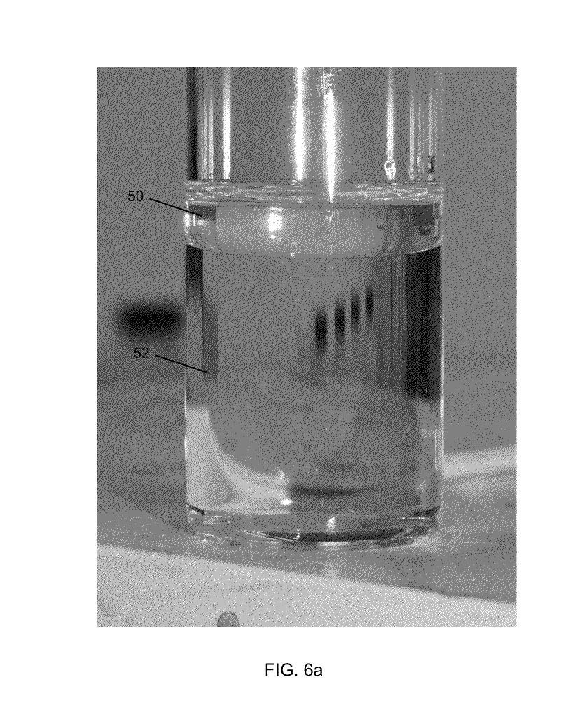

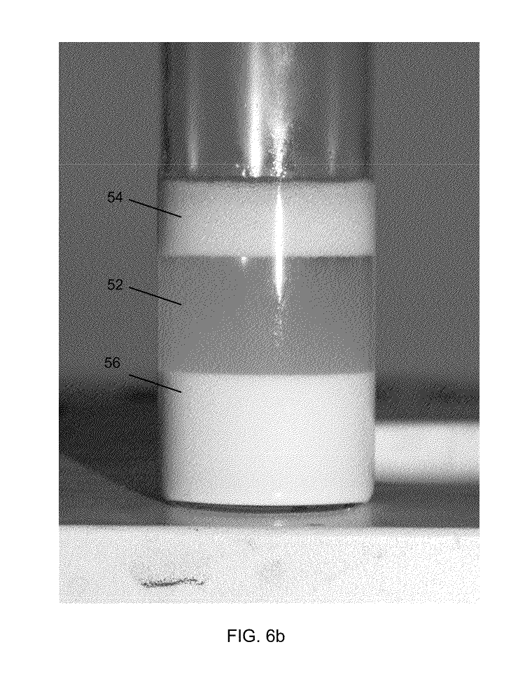

The present invention is further illustrated by reference to FIGS. 6a and 6b,

As shown in FIG. 6a gasoline 50 is immiscible with and lighter than water, forming a separate phase on top of the surface of the water. Almost all conventional materials/chemicals used in gasoline treatment/remediation either dissolve in water (e.g. hydrogen peroxide) or settle to the bottom.

In FIG. 6b the nano size calcium peroxide particles react with the gasoline to form the layer 54, while micro size particles of calcium peroxide settle to the bottom of the water column 52.

According to the present invention materials are prepared with apparent densities lighter than water and mix well with gasoline and other fuel oils. The peroxide nanoparticles release hydrogen peroxide which forms tiny gas bubbles attached to the nanoparticles. The combined gas bubbles on peroxide nanoparticles have a density lower than 1 kg/L. This allows direct contact and reaction between gasoline and peroxide nanoparticles. In comparison, none of the conventional materials/chemicals used in hydrocarbon remediation has this property.

Advantages of producing and using peroxide nanoparticles as taught by the present invention are:
Nanochemistry for Enhanced Contaminant Degradation. Calcium peroxide is a well-known solid oxidant. Peroxide nanoparticles (e.g., 20-40 nm) is at least 1,000 times smaller than the conventional calcium peroxides (sold as PermeOx, oxygen release compound or ORC). The peroxide nanoparticles presented in this application feature specific surface area over 30,000 m²/kg. The extremely large surface leads to rapid hydrocarbon oxidation and consequently low dose requirement for site remediation. Conventional calcium peroxides (PermeOx or ORC) have not been used as chemical oxidants due to the slow reactions. They are typically applied as oxygen release materials.

Nanophysics for subsurface transport. The number one problem using conventional solid peroxides (e.g., PermeOx and ORC) in soil and groundwater treatment is the difficulty in materials handling, dissolution, and subsurface injection. Dry powders of solid peroxides are difficulty to be dissolved or suspended in water, often create dust at the site of application. Peroxide nanoparticles are delivered as a liquid slurry and ready to be used without delay. The nanoscale size also minimizes the problem of gravity-induced sedimentation and makes it extremely easy to pump and inject into soil and groundwater. There is no well clogging or equipment obstruction.

The peroxide nanoparticles produced and used to illustrate the present invention were synthesized with food-grade materials. The end product is hydrated lime (Ca(OH)₂).

According to the present invention, application of peroxide particles can include the use of an activator such as heat, transition metal ions (e.g. iron II), and oxidants to initiate generation of hydroxyl radicals to enhance the oxidation reaction. Peroxide nano-size particles can be used as an oxygen release material, to enhance biodegradation and bioremediation, in combination with a reductant material such as zero valent iron nanoparticles and sulfuric acid to form a sequential oxidation-reduction or reduction-oxidation scheme for soil and ground water remediation or to adjust pH, Eh and alkalinity.

It is also within the scope of the present invention to synthesize nano-size peroxide particles by reacting calcium and/or magnesium nano-size oxides with hydrogen peroxide.

According to the present invention the following lists benefits of the present invention:
a) Applications of peroxide nanoparticles include oxidation and remediation of contaminated groundwater, soil and sediment.
b) Applications of peroxide nanoparticles include cleanup of oil spills.
c) Applications of peroxide nanoparticles include treatment of surface water.
d) Applications of peroxide nanoparticles include oxidation of industrial waste streams.
e) Applications of peroxide nanoparticles include treatment and remediation of gasoline, diesel, kerosene, jet fuel, and heating oils.
f) Applications of peroxide nanoparticles include treatment and remediation of aromatic hydrocarbons such as benzene, toluene, xylene and ethylbenzene.
g) Applications of peroxide nanoparticles include cleanup and remediation of leaking underground storage tanks
h) Applications of peroxide nanoparticles include oxidation and precipitations of certain metal ions.

Having thus described my invention what is desired to be secured by Letters Patent of the United States is set forth in the appended claims.

What is claimed is:

1. A method for treating contaminated soil and water comprising the steps of:
a) preparing a liquid slurry of particles of one of calcium dioxide, magnesium dioxide or mixtures thereof;
b) subjecting said slurry to one of a grinding or milling operation to produce particles of calcium dioxide, magnesium dioxide or mixtures thereof, said particles having an average size between 1 and 1000 nanometers; and
c) applying said particles to said contaminated soil and water.

2. A method according to claim 1 including the step of applying said particles to one of soil, water and soil and water containing one of gasoline, kerosene, diesel fuel, aircraft fuel, fuel oils, hydrocarbon compounds including benzene, toluene, xylene and ethylbenzene, MTBE, dioxane, ethanol and mixtures thereof.

3. A composition for treating contaminants in soil or water consisting of:
a slurry of one of solid or porous particles of one of calcium dioxide or magnesium dioxide having an average particle size of from 1 to 1000 nanometers.

4. A composition according to claim 3 wherein said particles have a size less than 500 nanometers.

5. A method of preparing nanoscale size particles of peroxide comprising the steps of:
preparing a suspension of particles having an average size greater than 1 μm of calcium dioxide, magnesium dioxide or mixtures thereof; and
milling or grinding said suspension until said particles have a size between 1 and 1000 nanometers.
